(19) United States
(12) Patent Application Publication
(10) Pub. No.: US 2006/0236079 A1
(43) Pub. Date: Oct. 19, 2006

(54) Unified single-core and multi-mode processor and its program execution method

(76) Inventors: Tay-Jyi Lin, Hsinchu (TW); Chein-Wei Jen, Hsinchu (TW); Chia-Hsien Liu, Hsinchu (TW); Chih-Wei Liu, Hsinchu (TW); I-Tao Liao, Hsinchu (TW); Po-Han Huang, Hsinchu (TW)

Correspondence Address: HARNESS, DICKEY & PIERCE, P.L.C., P.O. BOX 8910, RESTON, VA, 20195, US

(21) Appl. No.: 11/297,395

(22) Filed: Dec. 9, 2005

(30) Foreign Application Priority Data
Apr. 13, 2005 (TW) 94111749

(51) Int. Cl. G06F 9/44

(52) U.S. Cl. 712/229

(57) ABSTRACT

A unified single-core and multi-mode processor and its program execution method are provided. In an embodiment of this processor, a single instruction stream is different types of instructions randomly arranged in thereof. The processor switches its modes based on the type of a fetched instruction to execute the program corresponding to the fetched instruction.

### CROSS-REFERENCE TO RELATED APPLICATIONS

This non-provisional application claims priority under 35 U.S.C. § 119(a) on Patent Application No(s). 94111749 filed in Taiwan, R.O.C. on April 13, 2005 the entire contents of which are hereby incorporated by reference.

### BACKGROUND

1. Field of Invention

The invention relates to processor architecture and, in particular, to a single-core and multi-mode processor and its program execution method.

2. Related Art

Generally, an embedded system processes two kinds of tasks. The former processes the human-machine interface that interacts with the users and the flow control at the system level. The latter performs data processing and conversions, such as the compression and decompression of audio/video (AV) data. The characteristics of the former tasks are the needs for a large amount of decision making and routines that cannot be accurately predicted; that is, the program running is dynamically determined during the task execution. Therefore, the mechanisms as jumping, branching, and interrupts have to be enhanced. The characteristics of the latter tasks are repeated data flow and the requirements of powerful operation abilities.

Therefore, most of conventional embedded systems integrate a reduced instruction set computing (RISC) processor and a digital signal processor (DSP). The former performs the processing tasks of user interactions and program controls. The latter executes multimedia data processing that requires massive operations. This kind of platforms (called the dual-core platforms) uses two processors of different properties to process the tasks of their own expertise. An example is the baseband processor in the cell phone. The processor used in the conventional dual-core platform is mostly used independently in a single-core system. Therefore, the functions of the two processors may have some overlapping. In reality, the two processors will not achieve very high utilization in most applications.

Later on, the architecture of a single-processor with two working modes is proposed to process two kinds of tasks with different properties by switching the working modes. In a conventional dual-mode single-processor architecture, the concept of multi-thread is used to divide the tasks in a system into two threads, the general-purpose thread (e.g. program controls) and the data processing thread. In general, the data operated by the data processing thread are first stored in on-chip memory to avoid cache misses. Therefore, this architecture first executes the general-purpose thread when processing a task. When the processor accesses some data in the external memory, i.e. when the general-purpose thread has a cache miss, it is switched to the data processing thread to perform pure data computing tasks (usually involving a large amount of time). Once the data required by the general-purpose thread are obtained from the external memory, the task is switched from the data processing thread back to the general-purpose thread to continue the original processing (i.e. of the general-purpose thread). This is shown in FIG. 1, where the time axis is from left to right. The upper row is the general-purpose thread and the lower row is the data processing thread. The gray region is the normal data processing period, whereas the white region is the cache miss period. With reference to FIG. 2, in the conventional dual-mode single-processor architecture, a common grasping pipeline 110 and executing pipeline 120 are used to perform the data processing of two threads (general-purpose thread and data processing thread). However, two processing cores 130 and two different register files 140 are required to store the data of two threads. The mode of the processor can be changed only when switching the thread.

### SUMMARY

In view of the foregoing, an object of the invention is to provide a unified single-core and multi-mode processor and the program execution method thereof to solve various problems and limitations existing in the prior art.

According to the disclosed unified single-core and multi-mode processor and the program execution method thereof, a single instruction stream is randomly arranged with different types of instructions. The system switches to a corresponding mode according to the type of the instruction to process data.

To achieve the above object, the disclosed program execution method of the uimfied single-core and multi-mode processor comprises the following steps. First an instruction stream with multiple instructions, some of which involve more than one instruction type, is received. Afterwards, each instruction in the instruction stream is executed. In particular,- each instruction is executed according to the following steps. An identification (ID) operator in the instruction is identified to obtain the type of the instruction. An execution region of the processor mode is selected from a plurality of execution regions according to the instruction type. The execution regions refer to different modes of the processor and there is a common region in the execution regions. Finally, data processing is performed according to the instruction by the selected execution region. These three steps are repeated to process in sequence the instructions in the instruction stream until the data processing in the instruction stream is finished.

The instruction types include a RISC type and a DSP type. Correspondingly, the execution regions include a RISC mode and a DSP mode. When the instruction type is identified as the RISC type, a corresponding execution region in the processor mode is selected to perform program controls accordingly. When the instruction type is identified as the DSP type, another corresponding execution region in the processor mode is selected to perform data operations accordingly. Here, the execution region for program controls can be the RISC mode and that of the data operations can be the DSP mode.

The invention discloses a unified single-core and multi-mode processor that executes programs using a single instruction stream. The instruction stream contains a plurality of instructions, some of which have more than one instruction type. The processor includes a plurality of processing regions to selectively execute instructions according to their types. They belong to different modes and have a plurality of register files for storing processing data according to the instruction types. Here one of the processing regions is selected according to the instruction type to execute each instruction.

In addition, the processing regions include a first processing region and a second processing region. One of them is selected according to the instruction type to execute each instruction. A common region exists between the first and second processing regions to process data according to the instruction.

The common region includes: a plurality of functional units and a plurality of common register files. The functional unit processes data according to the instruction. The common register file is used as a data exchange region.

Besides, the first processing region can be a processing region of the RISC mode, and the second processing region can be a processing region of the DSP mode. The DSP can be a multi-issue digital signal processor. The second processing region can be installed with an extra register.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the working principle in conventional single processor architecture with dual modes;

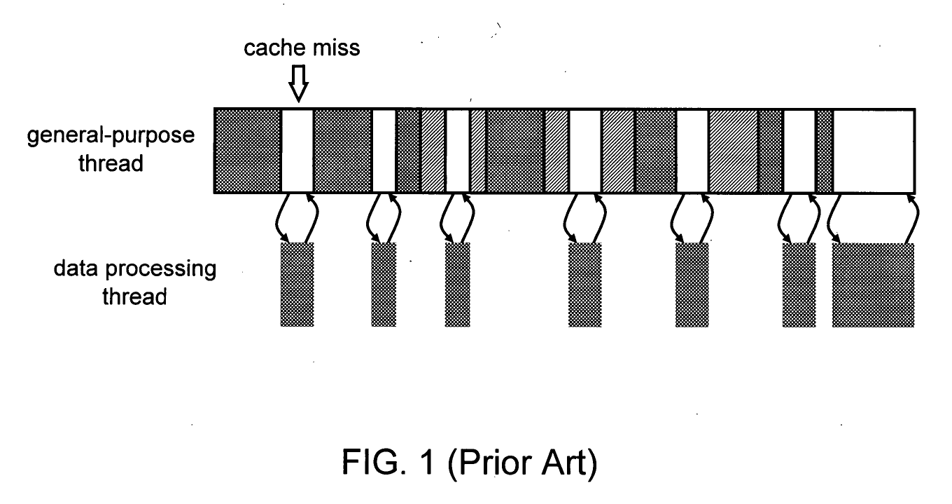

FIG. 2 is a structural diagram of conventional single processor architecture with dual modes;

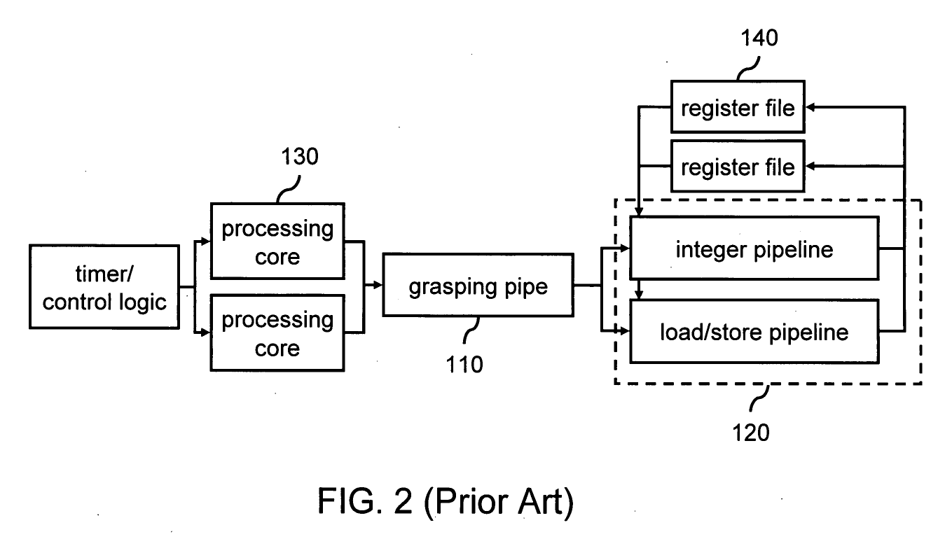

FIG. 3 is a flowchart of the program execution method of the unified single-core and multi-mode processor according to an embodiment of the invention;

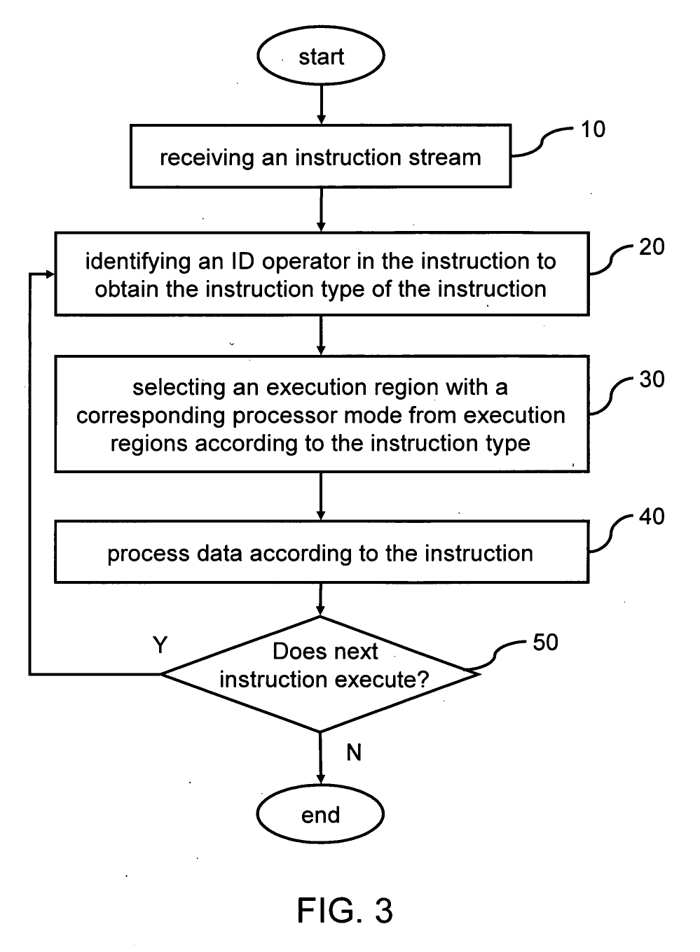

FIG. 4 is a section of the single instruction stream in an embodiment of the invention;

FIG. 5 shows the unified single-core and dual-mode processor according to an embodiment of the invention; and

FIG. 6 shows an example of the assembly language (left) and the corresponding virtual code (right) according to an embodiment of the invention.

### DETAILED DESCRIPTION

In conventional single-processor architecture, there are two instruction streams (i.e. the RISC thread and the DSP thread). When there is a cache miss during the processing of the RISC thread, the thread is switched and the processor mode is changed to execute the DSP instruction. After data are obtained from the external memory, the processor mode is changed back to the RISC mode and the thread is switched back to the RISC thread to continue the RISC instruction. However, the invention uses one single instruction stream for program controls. The instruction stream can be an arbitrary mixture of RISC and DSP instructions. When executing the instruction stream, the processor changes its mode according to the extracted instruction type to accomplish the execution of the instruction stream.

In the following, we refer to an explicit embodiment and the accompanying figures for explaining the contents of the invention. First, an instruction stream with a plurality of instructions, some of which have more than one instruction type, is received (step 10). The identification (ID) operator in each instruction is identified to obtain the instruction type (step 20). According to the instruction type, an execution region of the corresponding processor mode is selected from a plurality of execution regions (step 30). The data processing of the instruction is performed by the selected execution region (step 40). Steps 20 through 40 are repeated to process each instruction in the instruction stream before finishing the instructions (step 50).

When the computing requirement of the processor (e.g. for a DSP instruction), very long instruction words (VLIW's) can be used for instruction coding. Moreover, one can employ coding with a variable length to reduce the use of program memory. Therefore, the parallel operation method can be adopted in step 40 for data processing according to the corresponding instruction.

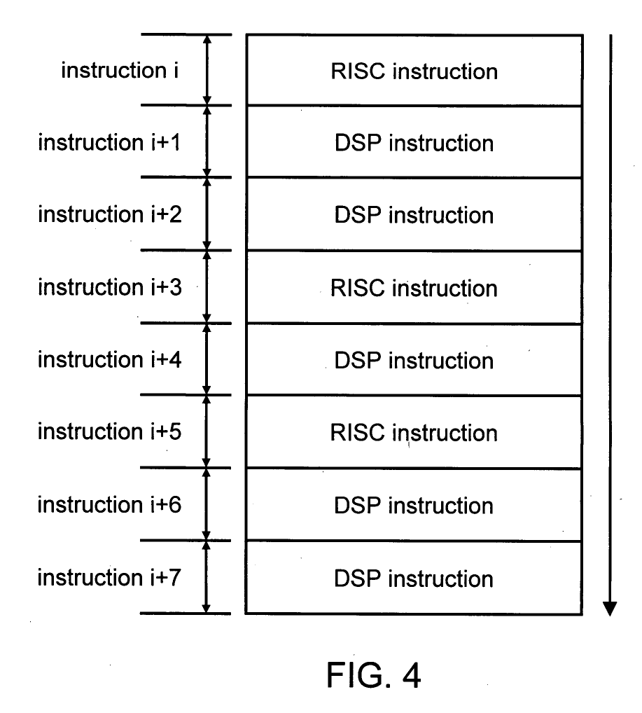

For simplicity, suppose there are the DSP and RISC two instructions types in an instruction stream, as in FIG. 4. Each instruction uses one bit (ID operator) in the instruction coding to represent whether it is a RISC or DSP instruction for subsequent decoding and operation tasks. As shown in the drawing, it is a section of a single instruction stream, where the ith instruction is a RISC instruction and the (i+l)th instruction is a DSP instruction. Therefore, the ID operator tells us that the ith instruction is a RISC instruction. At this moment, the processor plays the role of RISC. That is, the processor architecture constitutes a RISC processor to process program controls according to the instruction. The ID operator tells us that the (i+l)th instruction is a DSP instruction. At this moment, the processor plays the role of DSP. That is, the processor architecture constitutes a DSP processor to process data operations according to the instruction. Therefore, the single instruction stream can be arbitrarily mixed with two types of instructions. The processor reconfigures itself from instruction to instruction (becoming a RISC processor or a DSP processor). That is, when the extracted is a RISC instruction, the processor configures to be a RISC processor. Likewise, when the extracted is a DSP instruction, the processor configures to be a DSP processor. In other words, the processor mode switches according to the instruction stream to RISC, DSP, DSP, RISC, DSP, RISC, DSP, and DSP. The whole system completes the tasks in the above order. Besides, the operators required to be carried by the RISC instruction are not a lot. That is, the data processing quantity is not huge, meaning that the instruction length is shorter. However, the computations involved in the DSP instruction are a lot, meaning that it carries many operators. Therefore, the DSP instruction may be coded using the VLIW architecture and many functional units may be installed in the execution region to process data operations in parallel. In other words, the DSP instruction length can be increased with the number of fimctional units. Using the coding with a variable length, the hardware architecture is installed with many functional units so as to unify the DSP instructions in the VLIW mode into a single instruction stream without being limited by the RISC instructions.

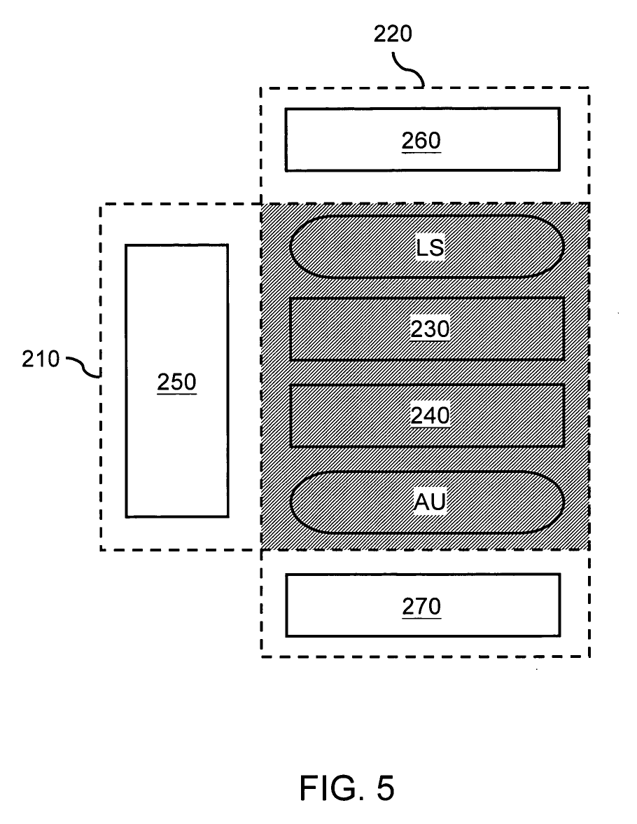

For an instruction stream of instructions with the DSP and RISC types, one may use hardware architecture as in FIG. 5 to implement the tasks. In this embodiment, a RISC and 2-issue DSP are unified to form a unified single-core and multi-mode processor. As shown in the drawing, the unified single-core processor in this embodiment uses dual-processing mode architecture. That is, the processor under the RISC mode is the first processing region 210. The processor under the DSP mode is the second processing region 220. There is a common region between them (the gray region in the drawing). In the common region, there are several functional units and several common register files. In the embodiment, the functional unit includes an access unit LS and an arithmetic unit AU for processing loading/storage instructions and operational instructions, respectively. The common register files 230, 240 are used as a data exchange region. Besides, the two processing regions 210, 220 have more than one register files 250, 260, 270 so as to store the processed data in each mode. In other words, with reference to FIGS. 4 and 5, when receiving the ith instruction the ID operator enables us to know that it is a RISC instruction. The processor configures itself in the RISC mode, i.e. the first processing region 210. It includes a common region and a register file 250. The register file 250 is used to store processing data. The common region has an access unit LS and an arithmetic unit AU, so as to process data using the corresponding functional unit (the access unit LS or the arithmetic unit AU) according to the received instruction. The common region further has several common register units 230, 240 as the data exchange region.

When receiving the (i+l)th instruction the ID operator enables us to know that it is a DSP instruction. The processor configures itself in the DSP mode, i.e. the second processing region 220. It includes a common region and register files 260, 270. The register files 260, 270 are used to store processing data. The common region has an access unit LS and an arithmetic unit AU, so as to process data using the corresponding functional unit (the access unit LS or the arithmetic unit AU) according to the received instruction. The common region further has several common register units 230, 240 as the data exchange region. Here since the unified DSP processor is a 2-issue DSP, it is accompanied with two register files 260, 270 for storing the processed data when the functional units are processing in parallel.

Although a unified 2-issue DSP is used for the purpose of illustration in this embodiment, one may use a unified multi-issue DSP (i.e. a 3-issue DSP, a 4-issue DSP, . . . , an N-issue DSP). Therefore, the second processing region is correspondingly installed with several extra register files (i.e. the register files outside the common region); that is, two, four, ... or N register files. Here N is a positive integer greater than 2. Moreover, the DSP of the invention can be a VLIW DSP.

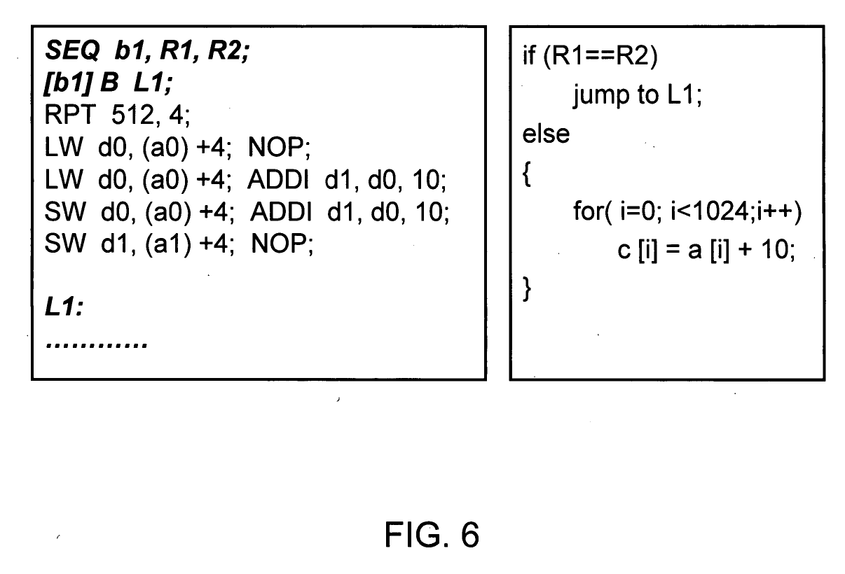

For example, FIG. 6 shows an assembly language (left) and the corresponding virtual program code (right) used in an embodiment of the invention. This assembly language example is a mixture of RISC and DSP instructions (the RISC instructions are labeled by bold italics). As shown in the drawing, the program first performs a determination. If R1=R2, the program jumps to L1; otherwise, a 1024 loop calculation is performed. That is, the RISC instruction processes program controls and the DSP instruction (the loop calculation in this example) process operations. Therefore, the whole system can be constructed using the assembly instructions. Simply put, the invention unifies the RISC processor and the DSP processor into a single-core and dual-mode processor. This processor can switch between the RISC mode and the DSP mode among different instructions according to the needs. Thus, the RISC and DSP instructions can be in the same instruction stream. Besides, the architecture can closely unify the RISC processor and the DSP processor. The data processing operations of the RISC processor are performed by the DSP engine. On the other hand, the thread of program controls is accomplished by the RISC mode. This architecture divides tasks precisely and the operations of the two modes interact closely. Therefore, it can achieve complete hardware resource sharing.

Certain variations would be apparent to those skilled in the art, which variations are considered within the spirit and scope of the claimed invention.

What is claimed is:

1. A program execution method of a unified single-core and multi-mode processor, comprising the steps of:
(A) receiving an instruction stream which have a plurality of instructions with at least one instruction type; and
(B) executing each of the instructions in the instruction stream, comprising the steps of:
(a) identifying an identification (ID) operator in the instruction to obtain the instruction type of the instruction;
(b) selecting an execution region with a corresponding processor mode from a plurality of execution regions according to the instruction type, wherein the execution regions are different processor modes and have a common region; and
(c) using the selected execution region to process data according to the instruction.

2. The program execution method of claim 1, wherein when the instruction types comprise a RISC instruction type and a DSP instruction type, the execution regions in step (b) comprise an execution region of a reduced instruction set computing (RISC) mode and an execution region of digital signal processing (DSP) mode.

3. The program execution method of claim 1, wherein when the instruction types comprising a RISC instruction type and a DSP instruction type, the step (c) comprises the steps of:
when the instruction type is identified as the RISC instruction type, using the selected execution region to execute program controls according to the instruction; and
when the instruction type is identified as the DSP instruction type, using the another selected execution region to execute data operations according to the instruction.

4. The program execution method of claim 1, wherein the instruction involving a huge amount of computation adopts a coding with a variable length and the step (c) is using the selected execution region to processing the data in parallel according to the instruction.

5. The program execution method of claim 4, wherein the instruction adopting the coding with the variable length is a DSP instruction.

6. A unified single-core and multi-mode processor for executing an instruction stream which have a plurality of instructions with at least one instruction type, comprising:
a plurality of processing regions, for selectively executing each of the instructions according to the instruction type of the instruction, wherein the processing regions share a common region for processing data according to the instruction and each of the processing regions has a plurality of register files for storing the data according to the executed instruction.

7. The unified single-core and multi-mode processor of claim 6, wherein the processing regions comprise:
a first processing region, which has the register files to selectively store the data according to the instruction; and
a second processing unit, which has the register files to selectively store the data according to the instruction;
wherein the first processing region and the second processing unit share the common region for processing the data according to the instruction.

8. The unified single-core and multi-mode processor of claim 7, wherein the first processing region is a RISC mode processing region and the second processing region is a DSP mode processing region.

9. The unified single-core and multi-mode processor of claim 8, wherein the DSP mode processing region is an N-issue DSP mode processing region where N is a positive integer greater than or equal to 2.

10. The unified single-core, and multi-mode processor of claim 9, wherein the N-issue DSP mode processing region is a 2-issue DSP processing region and comprises four of the register files.

11. The unified single-core and multi-mode processor of claim 7, wherein the common region comprises:
a plurality of functional units for processing the data according to the instruction; and
a plurality of common register files as a data exchange region.

12. The unified single-core and multi-mode processor of claim 6, wherein the common region comprises:
a plurality of functional units for processing the data according to the instruction; and
a plurality of common register files as a data exchange region.
